(19) United States
(12) Patent Application Publication
(10) Pub. No.: US 2010/0299627 A1
(43) Pub. Date: Nov. 25, 2010

(54) METHOD AND APPARATUS FOR CONTENT BOUNDARY DETECTION AND SCALING

(75) Inventor: JASON B. KENAGY, La Jolla, CA (US)

Correspondence Address: McDermott Will & Emery LLP, 600 13th Street, NW, Washington, DC, 20005-3096, US

(73) Assignee: QUALCOMM Incorporated, San Diego, CA (US)

(21) Appl. No.: 12/469,543

(22) Filed: May 20, 2009

(51) Int. Cl. G06F 3/048

(52) U.S. Cl. 715/800; 715/790

(57) ABSTRACT

A method and apparatus for displaying content on a communication device is provided. The method may comprise receiving content with a first display format in a communication device, wherein the communication device comprises a display having a device display area, detecting if the received content includes a discernable image boundary, wherein the discernable image boundary divides the content between at least a primary portion and a secondary portion, upon the detection of the discernable image boundary, masking as least the secondary portion of the content to generate content with a virtual second display format, scaling the generated content with the virtual second display format to substantially match at least one dimension associated with the device display area, and displaying the scaled content on the display on the communication device.

### BACKGROUND

### Background

The availability and variety of content made available for devices has increased with advances in distribution systems and display options. As content providers attempt to distinguish their content from competitors, a wide variety of display formats are being used. Additionally, mobile devices are similarly available with a variety of features and display area size options.

Existing content distribution systems limit the aspect ratio of content distributed to mobile devices. For example, content may be distributed with an aspect ratio of 4:3. Therefore, many mobile devices with display aspect ratios different than the distributed content aspect ratio may not fully utilize the display area available. For example, a mobile device may have a display area with an aspect ratio of 16:9. Generally, mobile devices have relatively small display areas for viewing content, which makes substantial utilization of the available display area important. Particularly, as depicted in FIG. 6, a mobile device display area may be formatted to display content in a different format than the format in which the content is configured to be displayed. For example, referring to FIG. 6A, when QVGA formatted content 604 is displayed on a display area with a QVGA aspect ratio 602, substantially all of the display area is utilized. In contrast, referring to FIG. 6B, when QVGA content includes letterbox formatting 606, then the displayed image does not fill the QVGA display area 602. Additionally, referring to FIG. 6C, when QVGA formatted content 604 is displayed on a display area with a W-QVGA aspect ratio 608, then portions of the display area are left unused. As a further example of a lack of display area utilization, referring to FIG. 6D, when QVGA content including letterbox formatting 606 is displayed on a display area with a W-QVGA aspect ratio 608, then portions above, below and to the sides of the content image on the display area are left unused. Thus, improved apparatus and methods for facilitating display of content using a substantial portion of a communication device display are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with displaying content on a communication device. According to one aspect, a method for displaying content on a communication device is provided. The method can comprise receiving content with a first display format in a communication device, wherein the communication device comprises a display having a device display area, detecting if the received content includes a discernable image boundary, wherein the discernable image boundary divides the content between at least a primary portion and a secondary portion, upon the detection of the discernable image boundary, masking as least the secondary portion of the content to generate content with a virtual second display format, scaling the generated content with the virtual second display format to substantially match at least one dimension associated with the device display area, and displaying the scaled content on the display on the communication device.

Another aspect relates to an apparatus. The apparatus can include a receiver module to receive content with a first display format in a communication device, wherein the communication device comprises a display having a device display area, an image boundary detection module to detect if the received content includes a discernable image boundary, wherein the discernable image boundary divides the content between at least a primary portion and a secondary portion, a masker module to mask as least the secondary portion of the content to generate content with a virtual second display format, upon the detection of the discernable image boundary, a scaler module to scale the generated content with the virtual second display format to substantially match at least one dimension associated with the device display area, and an output module to display the scaled content on the display on the communication device.

Yet another aspect relates to at least one processor configured to display content on a communication device. The at least one processor can include a first module for receiving content with a first display format in a communication device, wherein the communication device comprises a display having a device display area, a second module for detecting if the received content includes a discernable image boundary, wherein the discernable image boundary divides the content between at least a primary portion and a secondary portion, a third module for masking as least the secondary portion of the content to generate content with a virtual second display format, upon the detection of the discernable image boundary, a fourth module for scaling the generated content with the virtual second display format to substantially match at least one dimension associated with the device display area, and a fifth module for displaying the scaled content on the display on the communication device.

Still another aspect relates to a computer program product comprising a computer-readable medium. The computer-readable medium can include a first set of codes for causing a computer to receive content with a first display format in a communication device, wherein the communication device comprises a display having a device display area, a second set of codes for causing the computer to detect if the received content includes a discernable image boundary, wherein the discernable image boundary divides the content between at least a primary portion and a secondary portion, a third set of codes for causing the computer to mask as least the secondary portion of the content to generate content with a virtual second display format, upon the detection of the discernable image boundary, a fourth set of codes for causing the computer to scale the generated content with the virtual second display format to substantially match at least one dimension associated with the device display area, a fifth set of codes for causing the computer to display the scaled content on the display on the communication device.

Yet another aspect relates to an apparatus. The apparatus can include means for receiving content with a first display format in a communication device, wherein the communication device comprises a display having a device display area, means for detecting if the received content includes a discernable image boundary, wherein the discernable image boundary divides the content between at least a primary portion and a secondary portion, means for masking as least the secondary portion of the content to generate content with a virtual second display format, upon the detection of the discernable image boundary, means for scaling the generated content with the virtual second display format to substantially match at least one dimension associated with the device display area, and means for displaying the scaled content on the display on the communication device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an exemplary communication network for distribution of content with various display formats to communication devices with various display formats;

FIG. 2 illustrates an example architecture of a communication device;

FIG. 3 is an exemplary method for facilitating display of content using a substantial portion of the device display area;

FIGS. 4A-E illustrate exemplary screen shots of content displayed on communication devices;

FIG. 5 illustrates a block diagram of an exemplary wireless device that can facilitate display of content using a substantial portion of the device display area;

FIG. 6 illustrates exemplary screen shots of content displayed on a communication device with exemplary content and display area formatting.

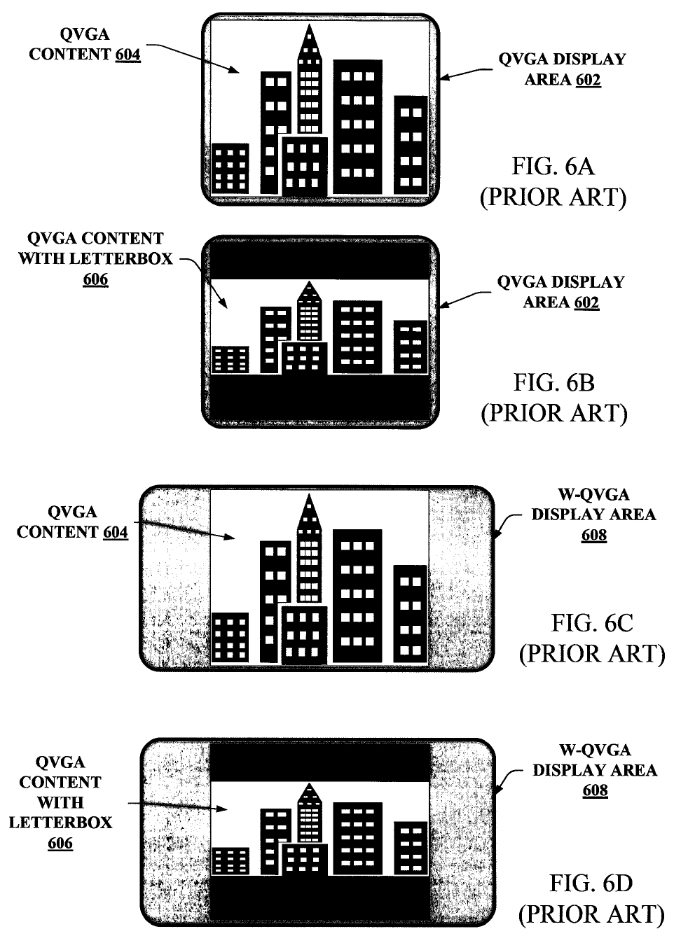

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

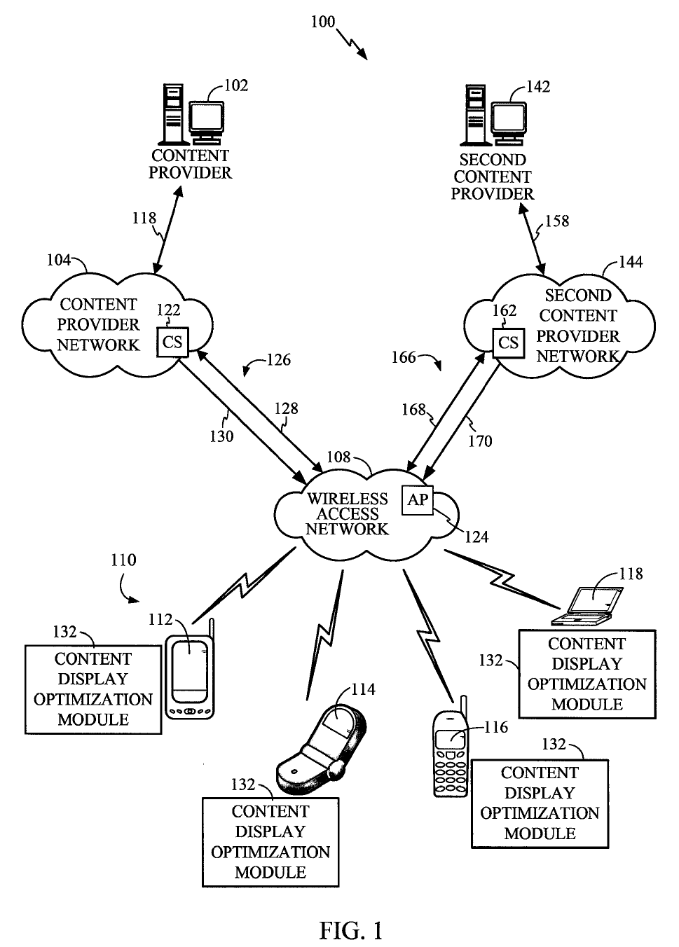

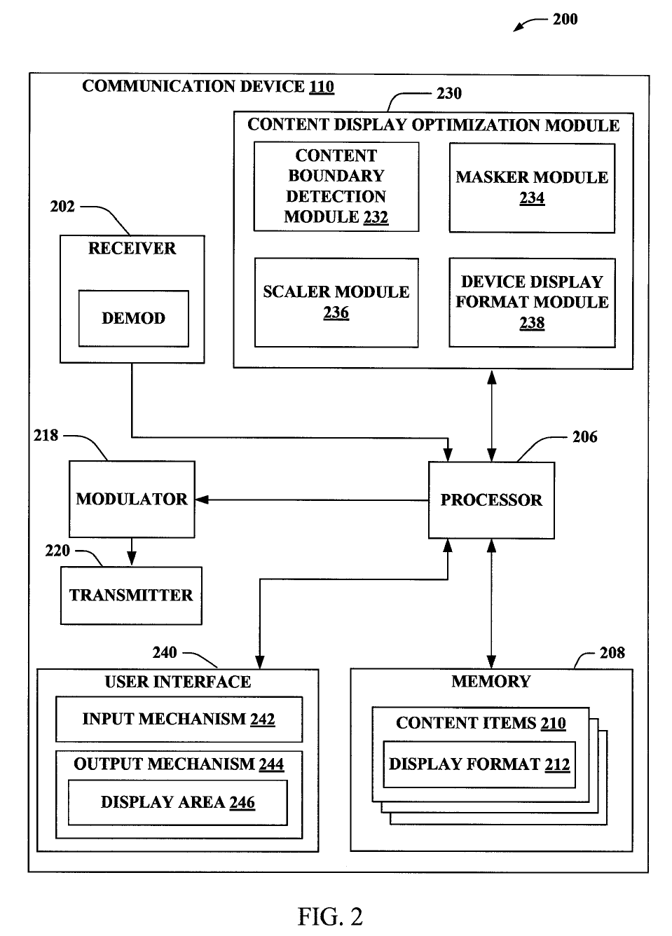

FIG. 1 shows one aspect of a communication network 100 that comprises a content transport system that operates to create and transport content across data networks. For example, the content transport system is suitable for use in transporting content from a content provider network to a wireless access network for broadcast/multicast or unicast distribution. Furthermore, for example, the content transport system is suitable for use in transporting content with various display formats to devices 110 including a content display optimization module 132, further described with reference to FIG. 2, to assist in presenting content that substantially fills the respective display areas of the displays of the respective devices 110. For example, content display optimization module 132 may analyze the aspect ratio of the content received from the content providers 102, 142, may analyze the display area aspect ratio of the device 110, and may manipulate the received content so that the images in the received content are displayed over a substantial portion of the display area of the device 110, e.g. to fill substantially all of the display area, in some aspects, without distorting the image in the content.

The depicted network 100 comprises content providers (CPs) 102, 142, content provider networks 104, 144, and a wireless access network 108. The network 100 may also include communication devices 110 that comprise various exemplary display sizes 112, 114, 116, and 118. The communication devices 110 illustrate just some of the devices that are suitable for use in one or more aspects of the content transport system, and such devices may include wireless devices and/or wired devices. It should be noted that although four devices are shown in FIG. 1, virtually any number of devices, or types of devices, are suitable for use in the transport system.

The content providers 102, 142 operate to provide content for distribution to users in the network 100. In the depicted illustration, multiple content providers are shown to demonstrate the possibility of various content providers providing content with a variety of display formatting. As used herein, “display formatting” relates to an aspect ratio of a content display area for presentation of the original. For example, content provider 102 may provide content with an image using an aspect ratio of 4:3, while content provider 142 may provide “letterbox” content, e.g. content with an image using an aspect ratio of 16:9 in a content display area having an aspect ratio of 4:3, or each content provider 102 and 142 may supply a plurality of content with a mixture of display formatting. The content may comprise video, audio, multimedia content, clips, graphics, text, real-time and non real-time content, scripts, programs, data or any other type of suitable content. The content providers 102, 142 provide content to the content provider networks 104, 144 for distribution. For example the content provider 102 communicates with the content provider network 104 via the communication link 118, which comprises any suitable type of wired and/or wireless communication link. Additionally, for example the content provider 142 communicates with the content provider network 144 via the communication link 158, which comprises any suitable type of wired and/or wireless communication link.

The content provider networks 104, 144, depicted in FIG. 1, comprise any combination of wired and wireless networks that operate to distribute content with any of a variety of display formats for delivery to users.

In one or more aspects, the transport system operates to deliver content from content providers 102, 142 for distribution to content servers (CSs) 122, 162 at the content provider networks 104, 144 that operate to communicate with an access point (AP) 124 at the wireless access network. The CSs 122, 162 and the AP 124 communicate using one or more aspects of transport interfaces 126, 166 that allow the content provider networks 104, 144 to deliver content to the wireless access network 108 for broadcast/multicast/unicast to the devices 110. In one aspect, for example, the transport interfaces 126, 166 comprise control interfaces 128, 168 and bearer channels 130, 170, respectively. The control interface 128 operates to allow the CS 122 to add, change, cancel, or otherwise modify content flows that flow from the content provider network 104 to the wireless access network 108. Similarly, the control interface 168 operates to allow the CS 162 to add, change, cancel, or otherwise modify content flows that flow from the content provider network 144 to the wireless access network 108. In one aspect, bearer channel 130 operates to transport the content flows from the content provider network 104 to the wireless access network 108. In another aspect, bearer channel 170 operates to transport the content flows from the content provider network 144 to the wireless access network 108. In one aspect, which should not be construed as limiting, the transport system may include the MediaFLO system available from Qualcomm, Incorporated of San Diego, Calif., although other broadcast, multicast and/or unicast transport systems may be utilized.

In one aspect, the CS 122 uses the transport interface 126 to schedule a content flow to be transmitted to the AP 124 for broadcast, multicast, and/or unicast over the wireless access network 108. For example, the content flow may comprise a non real-time content clip that was provided by the content provider 102 for distribution using the content provider network 104. In one aspect, the CS 162 operates to negotiate with the AP 124 to determine one or more parameters associated with the content clip. Once the AP 124 receives the content clip, it broadcasts/multicasts/unicasts the content clip over the wireless access network 108 for reception by one or more of the devices 110. Any of the devices 110 may be authorized to receive the content clip and cache it for later viewing by the device user. Furthermore, devices 110 may receive the content clips from various content providers with various display formats.

In one or more aspects, the transport system allows the CSs 122, 144 to receive program-guide records, program contents, and other related information from content providers 102, 142. The CSs 122, 144 may update and/or create content, program-guide records, program contents, and other related information for delivery to devices 110. For example, the CSs 122, 144 may provide content display aspect ratio information along with the content to facilitate optimal viewing on a device 110.

While still referencing FIG. 1, but turning also now to FIG. 2, an example architecture of a representative one of communication devices 110 is illustrated. As depicted in FIG. 2, in an example of a wireless communication device, communication device 200 comprises a receiver 202 that receives a signal from, for instance, a receive antenna (not shown), performs typical actions on (e.g., filters, amplifies, downconverts, etc.) the received signal, and digitizes the conditioned signal to obtain samples. Receiver 202 can comprise a demodulator 204 that can demodulate received symbols and provide them to a processor 206 for channel estimation. Processor 206 can be a processor dedicated to analyzing information received by receiver 202 and/or generating information for transmission by a transmitter 220, a processor that controls one or more components of communication device 200, and/or a processor that both analyzes information received by receiver 202, generates information for transmission by transmitter 220, and controls one or more components of communication device 200.

Communication device 200 can additionally comprise memory 208 that is operatively coupled to processor 206 and that can store data to be transmitted, received data, information related to available channels, data associated with analyzed signal and/or interference strength, information related to an assigned channel, power, rate, or the like, and any other suitable information for estimating a channel and communicating via the channel. In one aspect, memory 208 can include content items 210, such as but not limited to, user generated content, pictures, screen captures, voice recordings, graphics, text, multimedia, audio, video, etc. Furthermore, content items 210 may include display formats 212 corresponding to each of the content items 210. For example, display format 212 may define an aspect ratio in which the content is designed to be displayed. By way of example and not limitation, the aspect ratio may be one of 4:3, 5:4, 3:2, 8:5, 5:3, 16:9, 17:9 or the like.

It will be appreciated that the data store (e.g., memory 208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 208 of the subject systems and methods may comprise, without being limited to, these and any other suitable types of memory.

Additionally, communication device 200 may include user interface 240. User interface 240 may include input mechanisms 242 for generating inputs into communication device 200, and output mechanism 242 for generating information for consumption by the user of the communication device 200. For example, input mechanism 242 may include a mechanism such as a key or keyboard, a mouse, a touchscreen display, a microphone, etc. Further, for example, output mechanism 244 may include a display, an audio speaker, a haptic feedback mechanism, a Personal Area Network (PAN) transceiver, etc. In the illustrated aspects, the output mechanism 244 may include a display operable to present media content that is in image or video format or an audio speaker to present media content that is in an audio format. Additionally, in one aspect, output mechanism 244 may include a display with a known display area 246 defining at least the aspect ratio of the display screen.

Communication device 200 can further comprise content display optimization module 230 to facilitate displaying content using a substantial portion of the device display area 246, e.g. the size of a display screen, which is one form of an output mechanism 244 of device 200. Content display optimization module 230 may further comprise content boundary detection module 232 to assist content display optimization module 230 in differentiating between different portions of content items 210, such as primary and secondary portions. By way of example, and not limitation, the primary portion may include an image of a television program, sporting event, etc., and may include one or any combination of content displayed towards the center of display, content with data patterns that do not predictably repeat over a duration of time, content corresponding to metadata identifying a specific portion of the content as primary content, or the like. Furthermore, the secondary content may include black bars, such as at the edges of the image, e.g. for letterbox presentation, sidebars such as with content provider information, background or wallpaper patterns, etc. In one aspect, the content boundary detection module 232 may detect primary and/or secondary content portions by one or any combination of: detecting black portions signifying letterbox formatting; detecting portions of the content in which the displayed content is static; detecting portions of the content using a red, green and blue (RGB) scan; detecting portions of the content using a cyan, magenta, yellow and key/black (CMYK) scan; detecting discernable differences in images displayed within the display area, such as based on an image boundary detection algorithm, e.g. detecting a primary portion as an image corresponding to a sporting event, detecting a secondary portion as an image corresponding to a scoreboard corresponding to the sporting event, and/or detecting a tertiary portion corresponding to a top and bottom, and/or left and right side, border around the primary portion and/or secondary portion; or detecting the discernable image boundary through metadata that accompanies the received content.

Content display optimization module 230 may further comprise masker module 234 to assist content display optimization module 230 in masking at least a portion of the secondary content to facilitate effective display of the primary content on the device 200. In one aspect, the masker module 234, may deactivate, delete, crop, etc., at least a portion of the secondary content to create a revised content item with an aspect ratio at least partially defined by the primary content. For example, the masked content item may have an aspect ratio substantially similar to the primary content boundary, or may have a standard aspect ratio, such as but not limited to any one of 4:3, 5:4, 3:2, 8:5, 5:3, 16:9, or 17:9. For example, in some aspects, the masker module 234 creates the revised content item with an aspect ratio which most closely matches the aspect ratio of the primary content, which may include cropping portions of the original content or leaving some blank spaces on the device display at some edges of the content.

Further, content display optimization module 230 may further comprise device display format module 236 to further assist content display optimization module 230 in facilitating display of content using a substantial portion of the device display area 246. For example, device display format module 236 may obtain or otherwise determine device display area 246. Accordingly, device display format module 236 enables content display optimization module 230 to determine how to fit one or more images, e.g. primary and/or second image portions, of content within device display area 246 to maximize the size of the presented content within the display area 246.

Additionally, content display optimization module 230 may further comprise scaler module 236 to further assist content display optimization module 230 in facilitating display of content using a substantial portion of the device display area 246. In one aspect, device display format module 236 may determine the display area 246 of the communication device 200 and provide that information to the scaler module 236 to enable fitting of the content item to the display area. In some aspects, for example, scaler module 236 may proportionally increase the entire size of the content until all of the display area 246 is filled by the content images. For example, to avoid distorting the images within the content, such an increase in the size of the displayed content may involve cropping edges of the content. In another example, such an increase in the size may be proportional in all dimensions until the first two edges of the content meet a corresponding two edges of the display area 246, and the remaining two edges of the content may be left spaced apart from the corresponding remaining two edges of the display area 246. In yet another example, which results in slight distortion of the original images in the content, such an increase in the size may be proportional in all dimensions until the first two edges of the content meet a corresponding two edges of the display area 246, and then the content may be further increased in size in a single dimension until the remaining two edges of the content meet the corresponding remaining two edges of the display area 246.

More particularly, in one aspect, scaler module 236 may analyze aspect ratios of the content generated by the masker module 234 and the device display area 246, and may resize the generated content item to substantially match at least one dimension of the device display area 246. In one aspect, the scaler module 236 may substantially match the vertical dimension of the generated content with the vertical size of the device display area 246. Additionally, in this aspect, the scaler module 236 may further stretch or crop the generated content in the horizontal dimension to substantially match the horizontal size of the device display area 246. In another aspect, the scaler module 236 may not modify the horizontal dimension of the generated content, merely leaving blank space, which may allow for the corresponding portion of secondary content to be presented in the extra space, or the like. In still another aspect, the scaler module 236 may substantially match the horizontal dimension of the generated content with the horizontal size of the device display area 246. As such, the scaler module 236 may further stretch or crop the vertical dimension of the generated content to substantially match the vertical size of the device display area 246. In another aspect, the scaler module 236 may not modify the vertical dimension of the generated content, merely leaving blank space, which may allow for the corresponding portion of secondary content to be presented in the extra space, or the like. It should be noted that the use of the terms “horizontal” and “vertical” are relative, and are presented merely to provide exemplary references and are not intended to limit the scope of the claimed subject matter.

Furthermore, the masker module 234 and/or scaler module 236 may dynamically adjust the masking and/or scaling associated with the received content. For example, when new content with a different format is received in the communication device 200 the masker module and/or scaler module 236 may appropriately mask and/or scale the new content such as to present the new content in a manner that substantially fills the display area of the communication device. Additionally or in the alternative, the scaler module may dynamically modify scaling applied to the content when the aspect ratio of the display area changes. For example, if a user is viewing content on a device with an aspect ratio of 16:9, and then the user rotates the screen such that the aspect ratio is now 9:16. The scaler module 236 may rescale the content to as to present the content in light of the new aspect ratio. In another example, the aspect ratio of the content may change, such as when the content type changes, e.g. changing from a television program to a commercial or changing between two different programs, and as such scaler module 236 automatically adjusts the applied scaling based on the given content.

In another aspect, a user may manually adjust the masking and/or scaling. For example, through input mechanisms 242, a user may select to unmask content masked by the masker module 234. Further, a user may select whether to initially mask a portion of the content and/or to mask portions of the content while leaving other portions unmasked. Additionally, or in the alternative, a user may select to unscale content scaled by the scaler module 236. Further, a user may select or define an aspect ratio to which to scale content or portions of the content. Still further, a user may select to scale portions on the content with no distortion while scaling other portions in a distorted manner. For example, a user may select to scale a primary portion of the content, such as a sporting event portion, with no distortion, while scaling a secondary portion of the content, such as a sport scores ticker portion, with horizontal distortion to fill the horizontal dimension of the display area. Furthermore, a user may select to dynamically define areas of the display area for different portions of the content. For example, a user may arrange respective portions of the content at respective convenient locations of the display area.

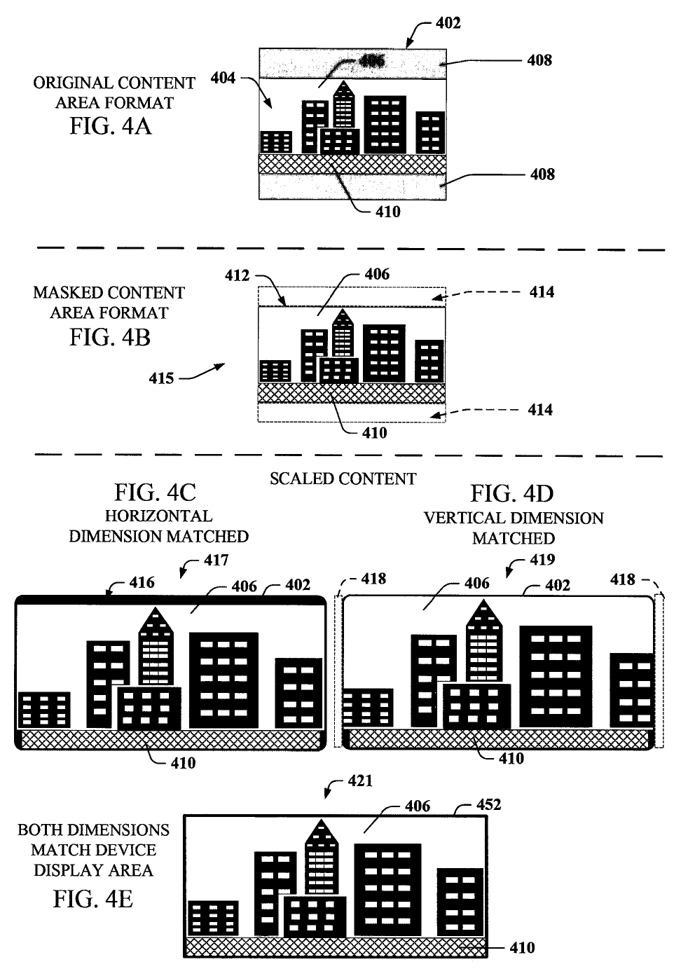

In operation, a user may prompt the communication device 200 through an input mechanism 242 to display content item 210 through an output mechanism 244 such as a screen display. The content display optimization module 230 may then receive the content item 210 including the corresponding content display format 212. Thereafter, the content boundary detection module 232 may analyze the content item 210 to distinguish between primary content and secondary content. The masker module 234 may then generate a revised content item from the received content item 210, wherein the revised content item substantially includes the primary content. The scaler module 234 may compare the generated revised content item aspect ratio with the device display area 246 that was retrieved by the device display format module 238. In one aspect, once the content item has been masked and scaled, the content is displayed to the user on the communication device 200 through the output mechanism 244 such that the images within the content fills or substantially fills the display area 246. Exemplary screen shots of multiple display options are presented and discussed in greater depth below with reference to FIG. 4.

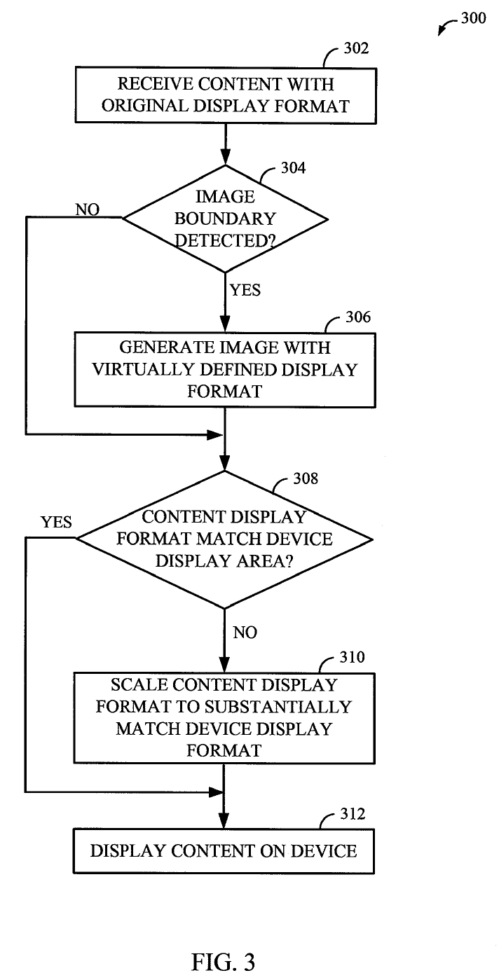

FIG. 3 illustrates various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 3, exemplary method 300 for facilitating display of content using a substantial portion of the device display area is illustrated. Generally, at reference numeral 302, content with an original display format is received by a device. For example, the content may be received from one of a plurality of content provider and stored in cache prior to playback, or streamed from at least one content provider for playback or the like. At reference numeral 304, it is determined whether the received content has a discernable boundary between primary content and secondary content. For example, secondary content portions may be detected by one or more of scanning for black portions of the content signifying letterbox formatting, detecting portions of the content in which the displayed content is static, detecting portions of the content using an RGB scan that include data intended to be displayed as black, detecting portions of the content using an CMYK scan that include data intended to be displayed black, detecting discernable differences in images displayed within the display area, such as based on an image boundary detection algorithm, or detecting the discernable image boundary through metadata that accompanies the received content. If at reference number 304 one or more discernable image boundaries are detected, then at reference numeral 306 a content item with an aspect ratio virtually defined to substantially be the boundaries of the primary content is generated. In one aspect, the new aspect ratio may be referred to as a virtual aspect ratio when the content item having an original aspect ratio is applied to a filter, mask, or the like to virtually define a different aspect ratio. In one aspect, secondary content may be deactivated, deleted, cropped, etc., to create a revised content item with an aspect ratio at least partially defined by the primary content. For example, the created content item may have an aspect ratio substantially similar to the primary content boundary, or may have a standard aspect ratio, such as but not limited to one of 4:3, 5:4, 3:2, 8:5, 5:3, 16:9, or 17:9, such as an aspect ratio which most closely matches the original aspect ratio of the primary content. By contrast, at reference numeral 304, if a discernable image boundary is not detected, then no virtual aspect ratio is generated for the received content and the logic proceeds to reference numeral 308.

At reference number 308, it is determined whether there is a match or substantial match between the device display area and the content display format. The content may include the generated virtual aspect ratio or the received content with no discernable image boundary, and hence the original display format. In one aspect, for the content display format and the device display area to substantially match, at least one parameter, such has display height or width, may be within a predefined threshold, such as 95%, to be considered matching.

If at reference numeral 308 it is determined that the content display format and the device display area do not substantially match, then at reference numeral 310, content is scaled to substantially match at least one parameter of the device display area, such as display height, width, or the like. In one aspect, content may be scaled by comparing the aspect ratios of the content and the wireless device display area, and the content may be resizes to substantially match at least one dimension of the wireless device display area. In one aspect, scaling may substantially match the vertical dimension of the content with the vertical dimension of the wireless device display area. As such, scaling may further stretch or crop the content in the horizontal dimension to substantially match the wireless device display area in the horizontal dimension. In another aspect, scaling may not modify the image in the horizontal dimension and merely leave blank space on the device display, may allow for the corresponding portion of secondary content to be presented in the blank space, or the like. In still another aspect, scaling may substantially match the horizontal dimension of the content with the horizontal dimension of the wireless device display area. As such, scaling may further stretch or crop the content in the vertical dimension to substantially match the wireless device display area in the vertical dimension. In another aspect, scaling may not modify the image in the vertical dimension and merely leave blank space, may allow for the corresponding portion of secondary content to be presented in the blank space, or the like.

At reference number 312, content may be displayed on the wireless device. For example, content such as content that has been scaled and masked, content that has been scaled but not masked, and content that has not been modified may be displayed.

With reference to FIGS. 4A-E, exemplary screen shots are illustrated depicting multiple display options for a communication device with a display 402 having a first aspect ratio operable to display original content item 404 originally transmitted with a second aspect ratio. As depicted in FIG. 4A, content 404, including a displayed image 406, e.g. a cityscape, has a different aspect ratio than the aspect ratio or display size of the display 402, e.g. such as when the content 404 is letterboxed. For example, a content provider may have originally prepared the content for transmission with an aspect ratio of 16:9 and may include blank spaces 408 at the top and bottom to transmit the content to the device using a 4:3 aspect ratio. Furthermore, in one aspect, the image displayed representing the received content 404 may include a primary portion 406, a secondary portion 408, and a tertiary portion 410. For example, during display of a sport event, a primary portion 406 may display the sporting field, a secondary portion 408 may be blank to allow for letterbox display or the like, or may include content provider information or the like, and a tertiary portion 410 may include scoreboard for the sport event or scores, scrolling text, etc., such as from various other sporting events. In another example, during display of a financial newscast, a primary portion 406 may display a commentator, a secondary portion 408 may be blank to allow for letterbox display or the like, or may include content provider information or the like, and a tertiary portion 410 may include a ticker with stock prices or the like.

FIG. 4B depicts an exemplary screen shot of content that has been manipulated on the communication device through a module such as the masker module depicted in FIG. 2. As such, the display area 414 that contained secondary content 408, such as blank spaces, have been masked to allow the displayed image of primary 406 to define the boundaries of the masked content item 415. In one aspect, optionally, the masked content item 415 may include tertiary content 410.

FIG. 4C depicts an exemplary screen shot of content that has been further manipulated on the communication device, through modules such as the masker module and the scaler module depicted in FIG. 2, to allow a masked, scaled content item 417 to substantially fill the display area. In the depicted example, primary content 406 has been scaled without distortion until it matched the horizontal dimension of the display area 402. As the display area 402 and the primary image 406 aspect ratio differ, blank space 416 may be left on the display area 402. Although illustrated on the top side, blank space 416 may alternatively be positioned on the bottom side of masked, scaled content item 417, or blank space 416 may be divided between the top and bottom sides. Alternatively or in addition, in operation, blank space 416 may remain blank so as to avoid image distortion, or may be filled through stretching the image to fill the space. Additionally, or in the alternative, the tertiary portion 410 of the content may also be displayed as part of masked, scaled content item 417. In one aspect, in contrast to the primary portion 406, the tertiary portion 410 aspect ratio may be modified to maintain the original height of the tertiary section while stretching the width to substantially fill the device display. In other aspects, the tertiary portion 410 may not be modified from its original sizing.

FIG. 4D depicts another exemplary screen shot of content that has been further manipulated on the communication device, through modules such as the masker module and the scaler module depicted in FIG. 2, a masked, scaled content item 419 to substantially fill the display area. In the depicted example, primary content 406 has been scaled without distortion until it matched the vertical dimension of the display area 402. As the display area 402 and the primary image 406 aspect ratio differ, left and right edges 418 of the primary portion 406 may be cropped to fit the display area 402.

FIG. 4E depicts yet another exemplary screen shot of content that has been further manipulated on the communication device, through modules such as the masker module and the scaler module depicted in FIG. 2, to allow a masked, scaled content item 421 to substantially fill the display area. In the depicted example, primary content 406 has been scaled without distortion until it filled the dimensions of the display area 452. Additionally, or in the alternative, the tertiary portion 410 of the content may also be displayed. In one aspect, in contrast to the primary portion 406, the tertiary portion 410 aspect ratio may be modified to maintain the original height of the tertiary section while stretching the width to substantially fill the device display. In other aspects, the tertiary portion 410 may not be modified prior to display. As the aspect ratios of display area 452 and the masked, scaled content item 421 are substantially similar, no cropping, stretching, and/or blank space may be present.

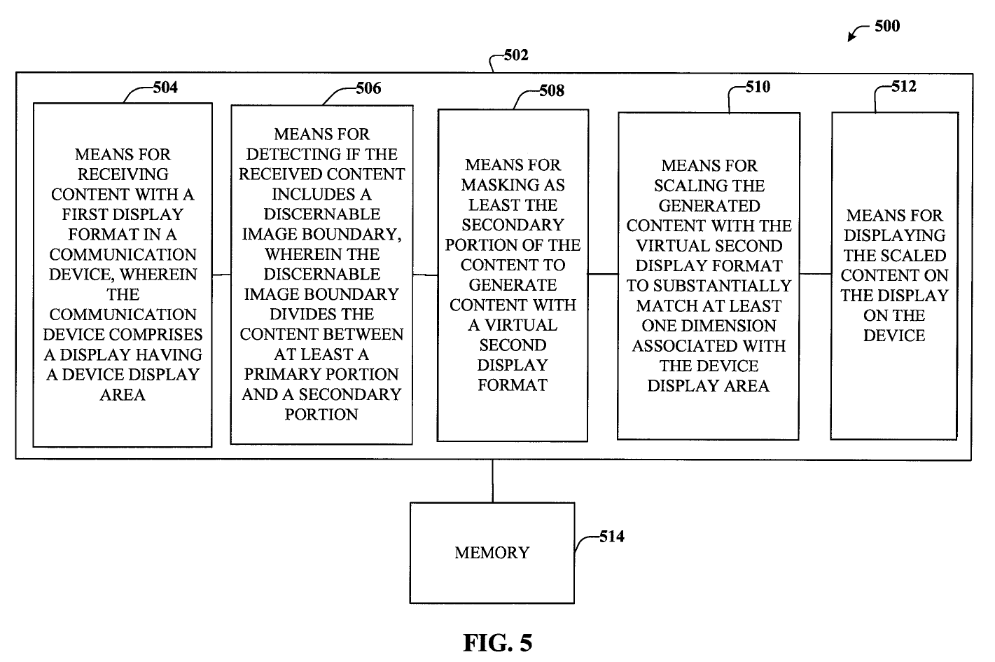

With reference to FIG. 5, a block diagram of an exemplary system 500 that can facilitate displaying content using a substantial portion of the wireless device display area is illustrated. For example, system 500 can reside at least partially within a wireless device. According to another example aspect, system 500 can reside at least partially within an access terminal. It is to be appreciated that system 500 is represented as including functional blocks, which can be functional blocks that represent functions implemented by a processor, software, or combination thereof (e.g., firmware). System 500 includes a logical grouping 502 of means that can act in conjunction. For instance, logical grouping 502 can include means for receiving content with a first display format in a communication device, wherein the communication device has a device display area corresponding to a display on the communication device 504. For example, the content may be received from a content provider prior to playback, from multiple content providers prior to playback, streamed from at least one content provider, stored on the wireless device cache, etc. Further, logical grouping 502 can comprise means for detecting if the received content includes a discernable image boundary, wherein the discernable image boundary divides the content between at least a primary portion and a secondary portion 506. For example, in one aspect, a content boundary detection module may detect secondary content portions by detecting black portions signifying letterbox formatting, detecting portions of the content in which the displayed content is static, detecting portions of the content using an RGB scan that include data intended to be displayed as black, or detecting portions of the content using an CMYK scan that include data intended to be displayed black, or detecting the discernable image boundary through metadata that accompanies the received content.

Further, logical grouping 502 can comprise means for masking as least the secondary portion of the content to generate content with a virtual second display format, upon the detection of the discernable image boundary 508. For example, content may be deactivated, deleted, cropped, etc., covering at least a portion of the secondary content to create a content item with an aspect ratio at least partially defined by the primary content. For example, the created content item may have an aspect ratio substantially similar to the primary content boundary, may have an aspect ratio of a standard aspect ratio, such as but not limited to one of 4:3, 5:4, 3:2, 8:5, 5:3, 16:9, or 17:9, which most closely matches the aspect ratio of the primary content, etc.

Further, logical grouping 502 can comprise means for scaling the generated content with the virtual second display format to match, within a predetermined threshold, at least one parameter associated with the device display area 510. For example, in one aspect, the scaler may substantially match the vertical dimension of the generated content with the vertical dimension of the wireless device display area. As such, the scaler may further stretch or crop the generated content in the horizontal dimension to substantially match the wireless device display area in the horizontal dimension. In another aspect, the scaler may not modify the image in the horizontal dimension and merely leave blank space, may allow for the corresponding portion of secondary content to be presented in the extra space, or the like. In still another aspect, the scaler may substantially match the horizontal dimension of the generated content with the horizontal dimension of the wireless device display area. As such, the scaler may further stretch or crop the generated content in the vertical dimension to substantially match the wireless device display area in the vertical dimension. In another aspect, the scaler may not modify the image in the vertical dimension and merely leave blank space, may allow for the corresponding portion of secondary content to be presented in the extra space, or the like. Further, logical grouping 502 can comprise means for displaying the scaled content on the display on the wireless device 512. As such, a wireless device may display content over a substantial portion of the display associated with the wireless device. Additionally, system 500 can include a memory 514 that retains instructions for executing functions associated with the means 504, 506, 508, 510, and 512. While shown as being external to memory 512, it is to be understood that one or more of the means 504, 506, 508, 510, and 512 can exist within memory 514.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM F, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method for displaying content on a communication device, the method comprising:
receiving content with a first display format in a communication device, wherein the communication device comprises a display having a device display area;
detecting if the received content includes a discernable image boundary, wherein the discernable image boundary divides the content between at least a primary portion and a secondary portion;
upon the detection of the discernable image boundary, masking as least the secondary portion of the content to generate content with a virtual second display format;
scaling the generated content with the virtual second display format to substantially match at least one dimension associated with the device display area; and
displaying the scaled content on the display on the communication device.

2. The method of claim 1 further comprising:
detecting a third display format in newly received content;
detecting if the newly received content includes a new discernable image boundary, wherein the new discernable image boundary divides the newly received content between at least a new primary portion and a new secondary portion;
upon the detection of the new discernable image boundary, masking at least the new secondary portion of the newly received content to generate new content with a virtual fourth display format;
scaling the generated new content with the virtual fourth display format to match at least one dimension associated with the device display area; and
displaying the scaled new content on the display on the communication device.

3. The method of claim 1 further comprising:
receiving a user selection to unmask the received content; and
displaying the received unmasked content on the communication device.

4. The method of claim 1 further comprising:
receiving a user selection to un-scale the generated content with the virtual second display format; and
display the un-scaled content on the communication device.

5. The method of claim 1 further comprising
receiving a user selection prompting the communication device to detect the discernable image boundary prior to detecting if the received content includes the discernable image boundary.

6. The method of claim 1, wherein the device display area is formatted to display content with an aspect ratio different than the first display format, and wherein scaling further includes resizing the first display format to match at least one dimension of the device display area.

7. The method of claim 6, wherein the first display format includes content formatted to be displayed with an aspect ratio of at least one of 4:3, or 5:4, or 3:2, or 8:5, or 5:3, or 16:9, or 17:9.

8. The method of claim 6, wherein the device display area is formatted to display content with an aspect ratio different than the first display format and wherein the device display area includes an aspect ratio of at least one of 4:3, or 5:4, or 3:2, or 8:5, or 5:3, or 16:9, or 17:9.

9. The method of claim 1, wherein detecting the discernable image boundary includes detecting image portions based on displayed image color.

10. The method of claim 8, wherein detecting image portions based on displayed image color further includes at least one of:
detecting black portions signifying letterbox formatting; or
detecting portions of the content using an RGB scan that include data intended to prompt the communication device to display black; or
detecting portions of the content using an CMYK scan that include data intended to prompt the communication device to display black.

11. The method of claim 1, wherein detecting the discernable image boundary includes detecting image portions based on relative variations in image data.

12. The method of claim 11, wherein detecting image portions based on relative variations in image data further includes at least one of:
detecting portions of the content in which the displayed content is static; or
detecting the discernable image boundary through metadata that accompanies the received content.

13. The method of claim 1, wherein the masked portions of the received content are not displayed on the communication device.

14. The method of claim 1, wherein the virtual second display format is formatted using at least one of:
the boundaries of the primary content as detected by the discernable image boundary; or
the boundaries of the primary content with a portion of the secondary content needed to generate a virtual aspect ratio equal to that of the device display area.

15. The method of claim 1, wherein scaling to generate content to substantially match at least one dimension associated with the device display area includes at least one of:
scaling the generated content such that a first dimension of the generated content matches a corresponding first dimension of the device display area; or
scaling the generated content such that a second dimension of the generated content matches a second dimension of the device display area; or
scaling the generated content such that a first dimension of the generated content matches the first dimension of the device display area, and stretching or cropping the generated content such that a second dimension of the generated content matches a second dimension of the device display area; or
scaling the generated content such that a second dimension of the generated content matches the second dimension of the device display area, and stretching or cropping the generated content such that a first dimension of the generated content matches the first dimension of the device display area.

16. The method of claim 16, wherein matching includes a result that the generated content in a selected dimension corresponds to within ninety five percent of the device display area in the selected dimension.

17. The method of claim 1, wherein detecting the discernable image boundary further includes detecting a tertiary portion of the content, and further comprising:
scaling the tertiary portion, using a different scaling factor than the scaling used for the generated content; and
displaying the scaled tertiary portion with the scaled content on the display on the communication device.

18. At least one processor configured to display content on a communication device:
a first module for receiving content with a first display format in a communication device, wherein the communication device comprises a display having a device display area;
a second module for detecting if the received content includes a discernable image boundary, wherein the discernable image boundary divides the content between at least a primary portion and a secondary portion;
a third module for masking as least the secondary portion of the content to generate content with a virtual second display format, upon the detection of the discernable image boundary;
a fourth module for scaling the generated content with the virtual second display format to substantially match at least one dimension associated with the device display area; and
a fifth module for displaying the scaled content on the display on the communication device.

19. A computer program product, comprising:
a computer-readable medium comprising:
a first set of codes for causing a computer to receive content with a first display format in a communication device, wherein the communication device comprises a display having a device display area;
a second set of codes for causing the computer to detect if the received content includes a discernable image boundary, wherein the discernable image boundary divides the content between at least a primary portion and a secondary portion;
a third set of codes for causing the computer to mask as least the secondary portion of the content to generate content with a virtual second display format, upon the detection of the discernable image boundary;
a fourth set of codes for causing the computer to scale the generated content with the virtual second display format to substantially match at least one dimension associated with the device display area;
a fifth set of codes for causing the computer to display the scaled content on the display on the communication device.

20. An apparatus, comprising:
means for receiving content with a first display format in a communication device, wherein the communication device comprises a display having a device display area;
means for detecting if the received content includes a discernable image boundary, wherein the discernable image boundary divides the content between at least a primary portion and a secondary portion;
means for masking as least the secondary portion of the content to generate content with a virtual second display format, upon the detection of the discernable image boundary;
means for scaling the generated content with the virtual second display format to substantially match at least one dimension associated with the device display area; and
means for displaying the scaled content on the display on the communication device.

21. An apparatus, comprising:
a receiver module to receive content with a first display format in a communication device, wherein the communication device comprises a display having a device display area;
an image boundary detection module to detect if the received content includes a discernable image boundary, wherein the discernable image boundary divides the content between at least a primary portion and a secondary portion;
a masker module to mask as least the secondary portion of the content to generate content with a virtual second display format, upon the detection of the discernable image boundary;
a scaler module to scale the generated content with the virtual second display format to substantially match at least one dimension associated with the device display area; and
an output module to display the scaled content on the display on the communication device.

22. The method of claim 21 further comprising:
a monitoring module to monitor the received content for a change in the content first display format;
wherein the detection module is further operable to:
detect a third display format in newly received content; and
detect if the newly received content includes a new discernable image boundary, wherein the new discernable image boundary divides the newly received content between at least a new primary portion and a new secondary portion;
wherein the masker module is further operable to mask at least the new secondary portion of the newly received content to generate new content with a virtual fourth display format, upon the detection of the new discernable image boundary;
wherein the scaler module is further operable to scale the generated new content with the virtual fourth display format to match at least one dimension associated with the device display area; and
wherein the output module is further operable to display the scaled new content on the display on the communication device.

23. The apparatus of claim 21 further comprising:
an input module to receive a user selection to unmask the received content; and
wherein the output module is further operable to display the received unmasked content on the communication device.

24. The apparatus of claim 21 further comprising:
an input module to receive a user selection to un-scale the generated content with the virtual second display format; and
wherein the output module is further operable to display the un-scaled content on the communication device.

25. The apparatus of claim 21 further comprising
an input module to receive a user selection prompting the communication device to detect the discernable image boundary prior to detecting if the received content includes the discernable image boundary.

26. The apparatus of claim 21 wherein the output module is further operable to display content with an aspect ratio different than the first display format, and wherein scaling further includes resizing the first display format to match at least one dimension of the device display area.

27. The apparatus of claim 26, wherein the first display format includes content formatted to be displayed with an aspect ratio of at least one of 4:3, or 5:4, or 3:2, or 8:5, or 5:3, or 16:9, or 17:9.

28. The apparatus of claim 26, wherein the device display area is formatted to display content with an aspect ratio different than the first display format and wherein the device display area includes an aspect ratio of at least one of 4:3, or 5:4, or 3:2, or 8:5, or 5:3, or 16:9, or 17:9.

29. The apparatus of claim 21, wherein the detection module is further operable to detect image portions based on displayed image color.

30. The apparatus of claim 29, wherein detecting image portions based on displayed image color further includes at least one of:
detecting black portions signifying letterbox formatting; or
detecting portions of the content using an RGB scan that include data intended to prompt the communication device to display black; or
detecting portions of the content using an CMYK scan that include data intended to prompt the communication device to display black.

31. The apparatus of claim 21, wherein the detection module is further operable to detect image portions based on relative variations in image data.

32. The apparatus of claim 31, wherein detecting image portions based on relative variations in image data further includes at least one of:
detecting portions of the content in which the displayed content is static; or
detecting the discernable image boundary through metadata that accompanies the received content.

33. The apparatus of claim 21, the masked portions of the received content are not displayed on the communication device.

34. The apparatus of claim 21, wherein the virtual second display format is formatted using at least one of:
the boundaries of the primary content as detected by the discernable image boundary; or
the boundaries of the primary content with a portion of the secondary content needed to generate a virtual aspect ratio equal to that of the device display area.

35. The apparatus of claim 21, wherein the scale is further operable to at least:
scale the generated content such that a first direction of the generated content matches the first direction of the device display area; or
scale the generated content such that a second direction of the generated content matches the second direction of the device display area; or
scale the generated content such that a first direction of the generated content matches the first direction of the device display area, and stretching or cropping the generated content such that a second direction of the generated content matches the second direction of the device display area; or
scale the generated content such that a second direction of the generated content matches the second direction of the device display area, and stretching or cropping the generated content such that a first direction of the generated content matches the first direction of the device display area.

36. The apparatus of claim 31, wherein the scaler module is further operable to match the display format of the generated content in a selected direction corresponds to within ninety five percent of the device display area in the selected direction.

37. The apparatus of claim 21, wherein the image boundary detection module is further operable to detect a discernable image boundary defining a tertiary portion of the content, wherein the scaler module is further operable to scale the tertiary portion, using a different scaling than the scaling used for the generated content; and wherein the output module is further operable to display the scaled tertiary portion with the scaled content on the display on the communication device.
